(19) United States
(12) Patent Application Publication
(10) Pub. No.: US 2016/0258489 A1
(43) Pub. Date: Sep. 8, 2016

(54) GARDEN TOOL QUICK RELEASE DEVICE

(71) Applicant: JYEN HERR ENTERPRISE CO., LTD., Changhua City (TW)

(72) Inventor: Kevin YAO, Changhua City (TW)

(21) Appl. No.: 14/706,692

(22) Filed: May 7, 2015

(30) Foreign Application Priority Data
Mar. 6, 2015 (TW) 104107169

(51) Int. Cl. F16D 1/10; F16B 7/04

(52) U.S. Cl. CPC F16D 1/10; F16B 7/0426

(57) ABSTRACT

A garden tool quick release device for connecting a transmission rod and a garden having a connection tube is disclosed to include a connection assembly including a first connection part for receiving the connection tube and a second connection part defining therein a second open chamber for receiving the transmission rod, and a latch assembly mounted at the first connection part for locking the connection tube to the first open chamber or releasing it from the constraint. Thus, the invention allows the user to change the garden tool rapidly, achieving the effect of convenience.

### BACKGROUND OF THE INVENTION

1. Field of the Invention

The present invention relates to garden tool technology and more particularly, to a garden tool quick release device.

2. Description of the Related Art

Conventional garden tools are roughly divided into car type and portable type. A portable garden tool generally comprises a motor, a transmission rod connected to the motor, a tool member, and a quick release device detachably connecting the tool member to the transmission rod. When wishing to change the tool member or if the tool member is damaged, the user needs to remove the tool member from the quick release device, and then attach another tool member to the quick release device.

Taiwan Utility M488848 discloses a lawn mower having a retractable shaft mechanism, which uses an adjustment device set to hold down an extension tube set, prohibiting an extension tube set of the extension tube set from movement relative to a fixed tube set. The adjustment device set comprises a sleeve and a locking member. The sleeve comprises an open chamber and two adjacent flanges. The locking member is threaded into each flange. The extension tube set is mounted in the open chamber. Rotating the locking member can move the two flanges toward or away from each other, thereby changing the inner diameter of the open chamber to lock or release the extension tube set. However, during the operation of the lawn mower that uses the locking member to lock the extension tube set, the extension tube set can slide relative to the fixed tube set easily due to vibration or if the locking member is not tightly fastened up. When this problem occurs, the user needs to adjust the extension tube set or to fasten tight the locking member again, causing great inconvenience in use.

Taiwan Utility M322148 discloses a garden tool transmission connection device, which has a lock pin mounted at one end of a connector. The lock pin has a stop ring, and is loaded with a spring. Matching between the spring and the stop ring enables the lock pin to lock a main shaft to one end of the connector. This design can prohibit the main shaft from sliding relative to the connector. However, when wishing to change the garden tool, the user needs to pull the lock pin out of the internal open chamber of the connector with one hand and to keep the lock pin outside the internal open chamber of the connector during change of the garden tool, and the user can release the hand from the lock pin only after change of the garden tool, enabling the lock pin to be forced by the spring to move into the inside the open chamber and to lock the newly loaded garden tool to the open chamber. Thus, using this garden tool transmission connection device still brings inconvenience to the user.

### SUMMARY OF THE INVENTION

The present invention has been accomplished under the circumstances in view. It is the main object of the present invention to provide a garden tool quick release device, which enhances user convenience in changing the garden tool, and avoids a secondary adjustment during the operation of the lawn mower due to vibration or loosening of the adjustment device set.

To achieve this and other objects of the present invention, a garden tool quick release device is adapted for connecting a transmission rod and a garden tool. The garden tool comprises a connection tube. The garden tool quick release device comprises a connection assembly and a latch assembly. The connection assembly comprises a first connection part and a second connection part. The first connection part comprises a first open chamber, a first insertion hole and a latch holder. The first open chamber is adapted for receiving the connection tube. The latch holder is disposed corresponding to the first insertion hole. The first insertion hole is disposed in communication between the first open chamber and the latch holder. The second connection part comprises a second open chamber adapted for receiving the transmission rod. The latch assembly comprises a latch pin. The latch pin comprises a locking tip and a shoulder. The latch pin is inserted through the latch holder and the first insertion hole. The latch pin is movable between a first position and a second position. When the latch pin is in the first position, the locking tip is positioned in the first open chamber. When the latch pin is in the second position, the shoulder is secured to the latch holder to prohibit the latch pin from movement relative to the first insertion hole and the latch holder, and at this time, the locking tip is disengaged from the first open chamber.

Preferably, the first connection part further comprises two adjacent flanges and a locking member. The two flanges are extended from the periphery of the first connection part, each comprising a first screw hole. The locking member is threaded into each first screw hole, and rotatable to move the two flanges toward or away from each other to further change the inner diameter of the first open chamber. The latch holder further comprises two sidewalls, a top panel, a retaining open chamber, a second insertion hole and two lugs. The two sidewalls are located at the periphery of the first connection part around the first insertion hole. The top panel is connected between the two sidewalls at a top side. The retaining open chamber is surrounded by the top panel, the two sidewalls and the first connection part. The second insertion hole is located at the top panel, and axially aligned with the first insertion hole. The two lugs are located at the top side of the top panel around the second insertion hole. The second connection part further comprises at least one second screw hole and at least one holding-down member. Each second screw hole cuts through the peripheral wall of the second connection part. The at least one holding-down member is respectively threaded into the at least one second screw hole, and rotatable to lock the transmission rod to the second open chamber, or to release the transmission rod from the second open chamber. The latch assembly further comprises a spring mounted around the latch pin and disposed in the retaining open chamber. The latch pin further comprises a finger-grippable head, an annular locating groove, and a stop member. The shoulder is latch holder is disposed corresponding to the two lugs. The stop member is fastened to the annular locating groove, and disposed in the retaining open chamber. The locking tip is inserted through the first insertion hole. The spring has two opposite ends thereof respectively stopped against the top panel and the stop member. When the latch pin is in the first position, the locking tip is positioned in the first open chamber, and the shoulder is set between the two lugs. When the latch pin is in the second position, the user can pull out the latch pin and rotate it through 90 degrees. At this time, the stop member compresses the spring against the top panel, the shoulder is supported on the two lugs to bridge the gap between the two lugs, and forced by the elastic potential energy of the spring to abut against the topmost edge of each of the two lugs.

Thus, shifting the latch pin between the first position and the second position can lock the connection tube to the first open chamber, or release the connection tube from the first open chamber. When the latch pin is moved to the second position, the latch pin is constantly kept in the second position, and the user needs not to continuously pull the latch pin. After the connection tube is adjusted or replaced, the user can shift the latch pin from the second position to the first position.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view illustrating a garden tool quick release device used in a lawn mower in accordance with the present invention.

FIG. 2 is an exploded view of the garden tool quick release device in accordance with the present invention.

FIG. 3 is a front view of the garden tool quick release device in accordance with the present invention.

FIG. 4 is a sectional view taken along line 4-4 of FIG. 3.

FIG. 5 is a sectional view of a part of the present invention, illustrating the latch pin in the first position.

FIG. 6 is a sectional view taken along line 6-6 of FIG. 5, illustrating the latch pin in the first position.

FIG. 7 is a sectional view of a part of the present invention, illustrating the latch pin in the second position.

FIG. 8 is a sectional view taken along line 8-8 of FIG. 7, illustrating the latch pin in the second position.

FIG. 9 is a schematic top view of the present invention, illustrating a different garden tool connected to the garden tool quick release device.

FIG. 10 is a schematic top view of the present invention, illustrating another different garden tool connected to the garden tool quick release device.

### DETAILED DESCRIPTION OF THE INVENTION

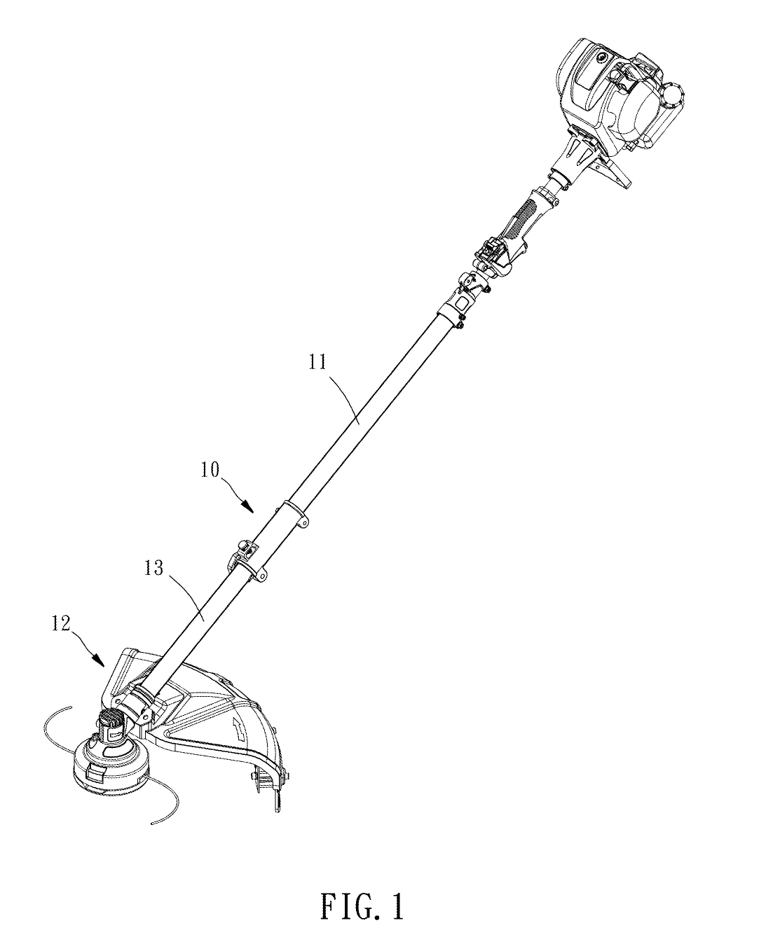

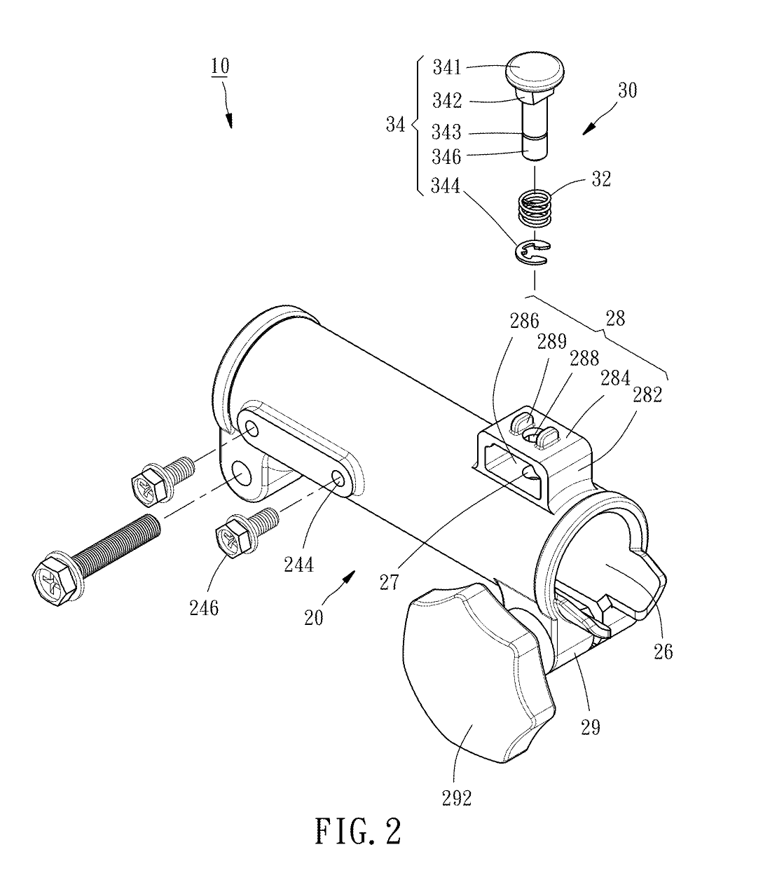

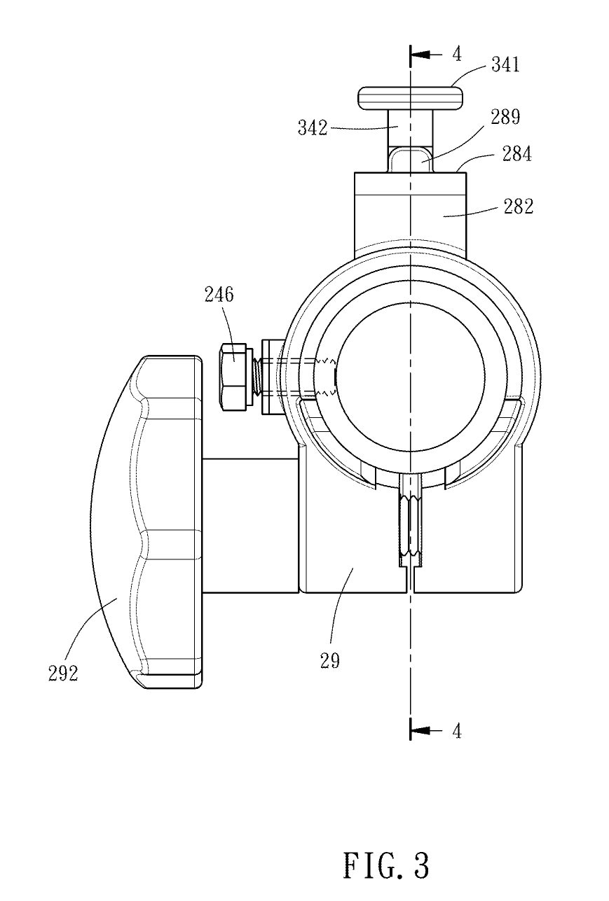

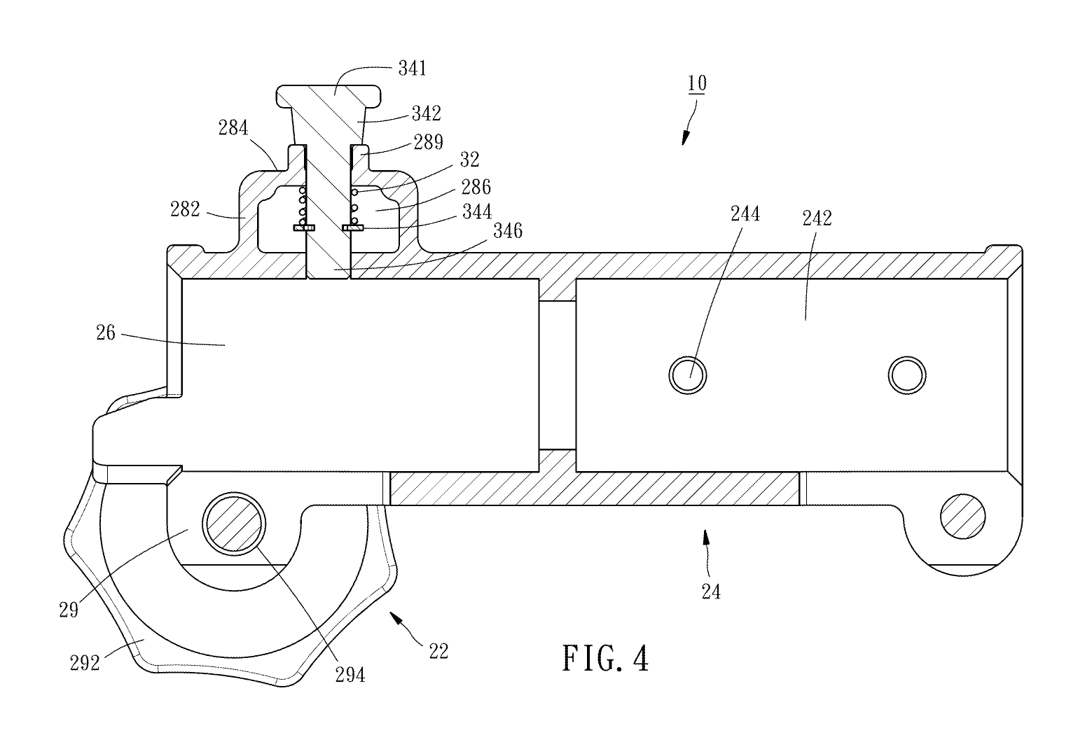

Referring to FIGS. 1-4, a garden tool quick release device 10 is shown adapted for connecting a transmission rod 11 and a garden tool 12. The garden tool 12 in this embodiment is a lawn mower cutter. The garden tool 12 comprises a connection tube 13. The connection tube 13 has at least one locating hole 14. The garden tool quick release device 10 comprises a connection assembly 20 and a latch assembly 30.

The connection assembly 20 has substantially a cylindrical shape. Further, the connection assembly 20 comprises a first connection part 22 and a second connection part 24 respectively located at two opposite ends thereof. The first connection part 22 comprises a first open chamber 26, a first insertion hole 27, a latch holder 28, two adjacent flanges 29 and a locking member 292. The first open chamber 26 is adapted for receiving the connection tube 13. The first insertion hole 27 cuts through the peripheral wall of the first connection part 22. The latch holder 28 is located at the peripheral wall of the first connection part 22 corresponding to the first insertion hole 27. The first insertion hole 27 is disposed in communication between the first open chamber 26 and the latch holder 28. The latch holder 28 comprises two sidewalls 282, a top panel 284, a retaining open chamber 286, a second insertion hole 288, and two lugs 289. The two sidewalls 282 are vertically located at the outer surface of the peripheral wall of the first connection part 22 around the first insertion hole 27. The top panel 284 is transversely connected between respective top sides of the two sidewalls 282. The retaining open chamber 286 is surrounded by the top panel 284, the two sidewalls 282 and the first connection part 22. The second insertion hole 288 is located at the top panel 284 in axial alignment with the first insertion hole 27. The two lugs 289 are vertically located at a top surface of the top panel 284 around the second insertion hole 288. The two flanges 29 are respectively symmetrically extended from the peripheral wall of the first connection part 22, each defining a first screw hole 294. The locking member 292 is a locking screw threaded into the first screw hole 294. Rotating the locking member 292 clockwise or counter-clockwise can force the two flanges 29 to move toward or away from each other, thereby changing the inner diameter of the first open chamber 26. The second connection part 24 comprises a second open chamber 242, two second screw holes 244, and two holding-down member 246. The second open chamber 242 is adapted for receiving the transmission rod H. The two second screw holes 244 cut through the peripheral wall of the second connection part 24. The two holding-down members 246 are holding-down screws respectively threaded into the two second screw holes 244, and rotatable to hold down the transmission rod 11 in the second open chamber 242 or to release the transmission rod 11 from the constant.

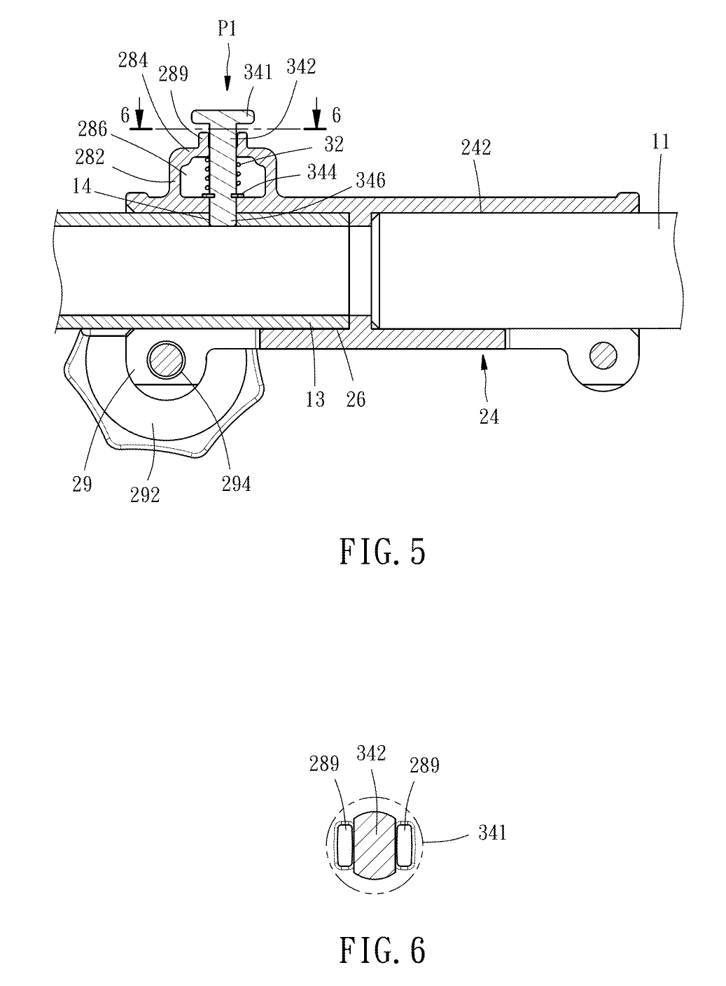

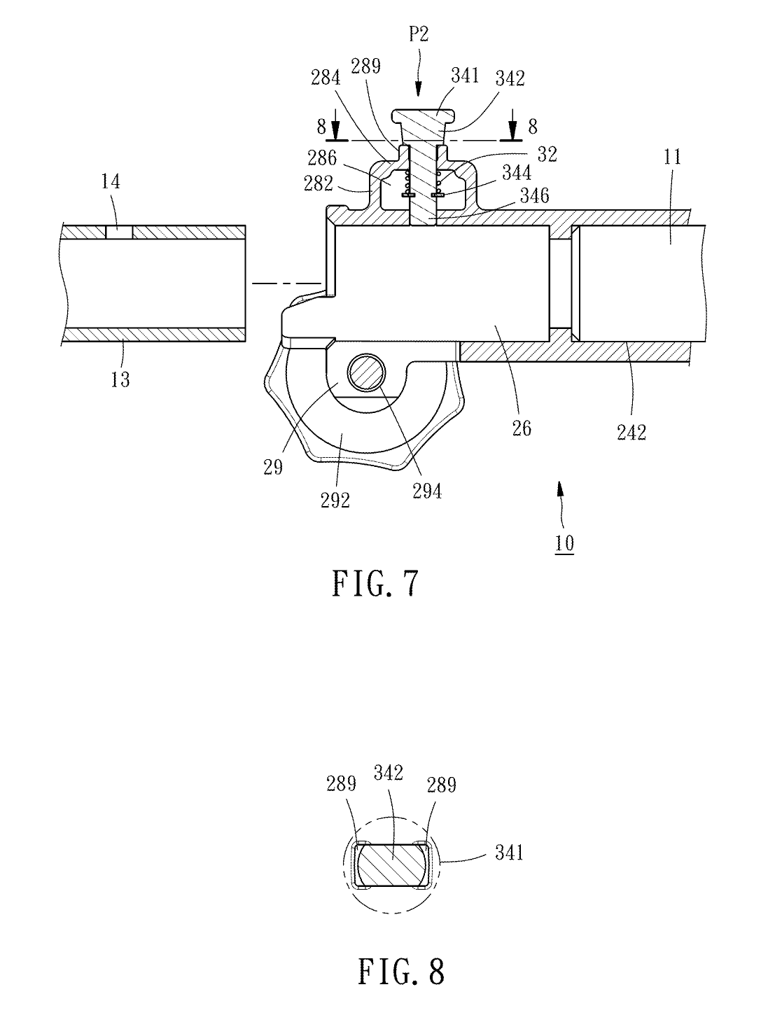

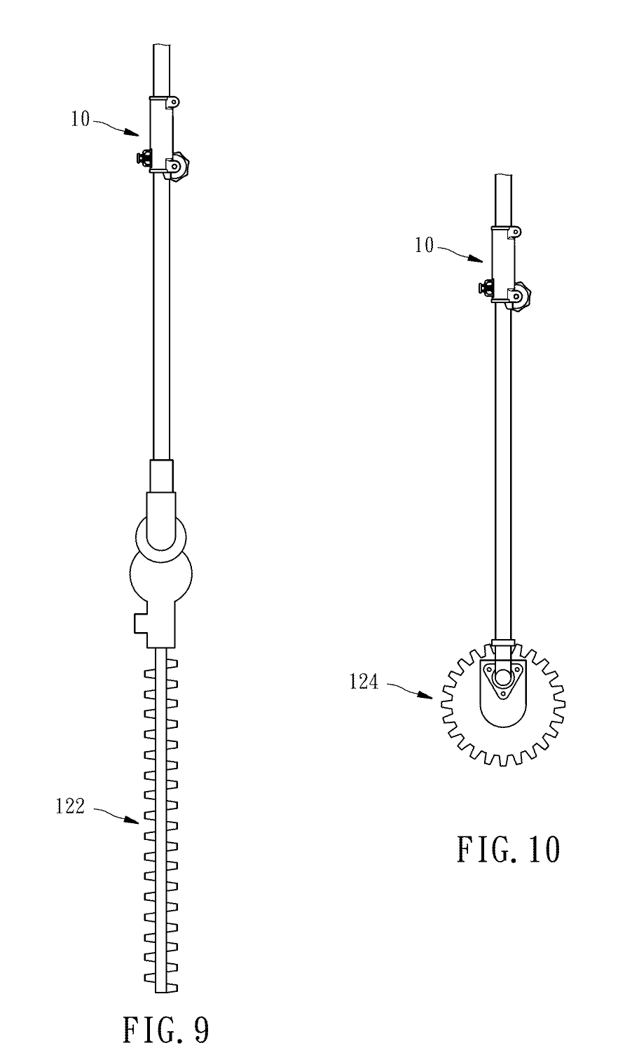

The latch assembly 30 comprises a spring 32 and a latch pin 34. The latch pin 34 is inserted into the first insertion hole 27 and the second insertion hole 288. The spring 32 is mounted around the latch pin 34, and positioned in the retaining open chamber 286. The latch pin 34 comprises a finger-grippable head 341, a shoulder 342, an annular locating groove 343, a stop member 344, and a locking tip 346. The shoulder 342 is disposed at the lugs 289. The stop member 344 in this embodiment is a C-shaped retainer. The stop member 344 is mounted in the annular locating groove 343 and disposed in the retaining open chamber 286. The locking tip 346 is inserted through the first insertion hole 27. The spring 32 has two opposite ends thereof respectively stopped against the top panel 284 and the stop member 344. The latch pin 34 is movable between a first position P1 and a second position P2. As shown in FIG. 5 and FIG. 6, when the latch pin 34 is in the first position P1, the locking tip 346 of the latch pin 34 is inserted through the first insertion hole 27 into the inside of the first open chamber 26, the shoulder 342 is disposed in between the two lugs 289. As illustrated in FIG. 7 and FIG. 8, when the latch pin 34 is in the second position P2, pull out the latch pin 34 and then rotate it through 90 degrees and then release is from the hand, the stop member 344 compresses the spring 32 against the top panel 284. At this time, the shoulder 342 bridges the gap between the two lugs 289 and is forced by the elastic potential energy of the spring 32 to abut against the topmost edge of each lug 289, and the locking tip 346 of the latch pin 34 is kept outside the first open chamber 26. Because the shoulder 342 is tightly supported above the two lugs 289, the latch pin 34 is prohibited from movement relative to the first insertion hole 27 and the second insertion hole 288.

Further, based on the above-described technical features of the present invention, as shown in FIG. 5 and FIG. 6, the first open chamber 26 receives the connection tube 13, and the locating hole 14 is disposed corresponding to the first insertion hole 27; when the latch pin 34 is in the first position P1, the latch pin 34 is inserted through the first insertion hole 27, the second insertion hole 288 and the locating hole 14 and the shoulder 342 is set in between the two lugs 289, and therefore, the latch pin 34 locks the connection tube 13 in the first open chamber 26. As shown in FIG. 7 and FIG. 8, when wishing to remove the connection tube 13 from the first open chamber 26, pull out the latch pin 34 and rotate it through 90 degrees and then release it from the hand, at this time, the shoulder 342 is disposed above the two lugs 289 and bridges the gap between the two lug 289, the locking tip 346 is disengaged from the locating hole 14, and the stop member 344 compresses the spring 32 against the top panel 284. At this time, the elastic potential energy of the spring 32 causes the shoulder 342 to be firmly stopped above the two lugs 289 to prohibit the latch pin 34 from movement relative to the first insertion hole 27 and the second insertion hole 288. Because the locking tip 346 is disengaged from the locating hole 14 at this time, the connection tube 13 is unlocked and can be freely moved out of the first open chamber 26.

Preferably, the user can rotate the locking member 292 to move the two flanges 29 toward each other and to further reduce the inner diameter of the first open chamber 26. This operation can hold down the first connection part 22 tightly to the connection tube 13, enhancing the structural strength.

Referring to FIG. 9 and FIG. 1, the garden tool quick release device 10 is applicable can be used for the mounting of any other garden tool that has a transmission rod for connection to the garden tool quick release device 10, such as chainsaw 122 or circular saw 124.

It's worth mentioning that a conventional garden tool quick release device normally uses one single locking member and has it be threaded into the connection assembly, allowing the locking member to be rotated to reduce or increase the inner diameter of the open chamber of the connection assembly and to further lock the connection tube to the connection assembly. When the user uses the lawn mower that uses this conventional design of garden tool quick release device, the connection tube can slide accidentally due to vibration or loosening of the locking member, complicating the application. Alternatively, a conventional garden tool quick release device may simply uses a lock pin and has the lock pin be inserted through the connection assembly into the open chamber to lock the connection tube to the open chamber. When wishing to adjust the connection tube, the user must pull up the lock pin for allowing adjustment, and then insert the lock pin into the open chamber to lock the connection tube after adjustment. This operation procedure is also inconvenient. The garden tool quick release device 10 of the invention uses a connection assembly 20 to work with a latch assembly 30. The connection assembly 20 comprises a first connection part 22. The first connection part 22 comprises a first open chamber 26 adapted for receiving the connection tube 13. The latch assembly 30 is located at the first connection part 22. Further, the latch assembly 30 comprises a latch pin 34. The latch pin 34 is inserted into the first connection part 22 to lock the connection tube 13 to the first open chamber 26. The latch pin 34 is movable between a first position P1 to lock the connection tube 13 to the first open chamber 26, and a second position P2 to release the connection tube 13 from the first open chamber 26. When the latch pin 34 is in the second position P2, the user needs not to pull the latch pin 34, and the latch pin 34 is constantly kept in the second position P2. After adjusted the connection tube 13, the user simply needs to shift the latch pin 34 from the second position P2 to the first position P1. In conclusion, the garden tool quick release device of the invention involves an inventive step.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A garden tool quick release device adapted for connecting a transmission rod and a garden tool, said garden tool comprising a connection tube, said garden tool quick release device comprising:
a connection assembly comprising a first connection part and a second connection part, said first connection part comprising a first open chamber, a first insertion hole and a latch holder, said first open chamber being adapted for receiving said connection tube, said latch holder being disposed corresponding to said first insertion hole, said first insertion hole being disposed in communication between said first open chamber and said latch holder, said second connection part comprising a second open chamber adapted for receiving said transmission rod; and
a latch assembly comprising a latch pin inserted through said latch holder and said first insertion hole and movable relative to said latch holder between a first position and a second position, said latch pin comprising a locking tip and a shoulder, said locking tip being disposed in said first open chamber when said latch pin is in said first position, said shoulder being secured to said latch holder to stop said latch pin from movement relative to said first insertion hole and said latch holder and said locking tip being disposed outside said first open chamber when said latch pin is in said second position.

2. The garden tool quick release device as claimed in claim 1, wherein said latch holder comprises two sidewall, a top panel, a retaining open chamber, a second insertion hole and two lugs, said two sidewalls being located at the periphery of said first connection part around said first insertion hole, said top panel being located at a top side of said two sidewalls, said retaining open chamber being surrounded by said top panel, said two sidewalls and said first connection part, said second insertion hole being located at said top panel and axially disposed in alignment with said first insertion hole, said two lugs being located at said top panel around said second insertion hole.

3. The garden tool quick release device as claimed in claim 2, wherein said latch assembly further comprises a spring mounted around said latch pin and disposed in said retaining open chamber; said latch pin further comprises a finger-grippable head, an annular locating groove and a stop member, said shoulder being disposed at said two lugs of said latch holder, said stop member being fastened to said annular locating groove and disposed in said retaining open chamber, said locking tip being inserted into said first insertion hole, said spring having two opposite ends thereof respectively stopped against said top panel and said stop member.

4. The garden tool quick release device as claimed in claim 3, wherein when said latch pin is in said first position, said shoulder is disposed in between said two lugs; when said latch pin is in said second position pulling out said latch pin and then rotating said latch pin through 90 degrees causes said stop member to compress said spring against said top panel and said shoulder to bridge the gap between said two lugs and to be forced by the elastic potential energy of said spring to stop at the topmost edge of each of said two lugs.

5. The garden tool quick release device as claimed in claim 1, wherein said first connection part further comprises two flanges and a locking member, said two flange being respectively extended from the periphery of said first connection part, each said flange comprising a first screw hole, said locking member being threaded into each said first screw hole and rotatable in one of two reversed directions to move said two flanges in direction toward or away from each other to further change the inner diameter of said first open chamber.

6. The garden tool quick release device as claimed in claim 1, wherein said second connection part further comprises at least one second screw hole and at least one holding-down member, each said second screw hole extending through a peripheral wall of said second connection part, said at least one holding-down member being respectively threaded into said at least one second screw hole and rotatable to lock said transmission rod to said second open chamber or to release said transmission rod from said second open chamber.
